(19) United States
(12) Patent Application Publication
(10) Pub. No.: US 2017/0282335 A1
(43) Pub. Date: Oct. 5, 2017

(54) LOCKING PLIERS

(71) Applicant: SHENG-YUAN HUANG, Taichung City (TW)

(72) Inventor: SHENG-YUAN HUANG, Taichung City (TW)

(21) Appl. No.: 15/088,584

(22) Filed: Apr. 1, 2016

(51) Int. Cl. B25B 7/12

(52) U.S. Cl. CPC B25B 7/123

(57) ABSTRACT

A locking pliers is provided, including a first clamp assembly, a second clamp assembly, a connecting member and an adjustment threaded rod. The first clamp assembly has a fixed jaw and a fixed grip. The second clamp assembly has a movable jaw, a movable grip, an operation member and a sleeve, the movable jaw is pivoted to the first clamp assembly, the movable grip is swingably assembled to the movable jaw, the sleeve is sleeved on the operation member, and the sleeve and the operation member are coaxially pivoted to the movable grip. The connecting member is pivoted to the movable grip and movably assembled to the fixed grip, and the connecting member selectively abuts against the operation member. The adjustment threaded rod is movably screwed to the fixed grip.

### BACKGROUND OF THE INVENTION

### Field of the Invention

The present invention relates to a locking pliers.

### Description of the Prior Art

In a conventional locking pliers, through a linkage mechanism, a user can clamp an object tightly with a small strength, and a jaw portion can extend into a small space for operation. In addition, the fixed clamp has a simple structure and is easy to be operated, and the locking pliers mostly has an operation member. After the locking pliers clamps the object, the user only needs to press the operation member, and then the movable jaw and the fixed jaw can quickly release the object. This type of locking pliers is disclosed in TWM425027.

However, in TWM425027, the operation member and a movable grip may have a gap therebetween, so the user may pinch him/herself accidentally. Consequently, in TWM254314 and TWM452836, the movable grip is extended to cover the operation member. However, the user may still be pinched, and a weight of the locking pliers largely increases. In U.S. Pat. No. 6,857,342, although a sleeve covers the gap, the locking pliers is still heavy, and the sleeve may fall off and get lost easily. The same disadvantage may be seen in TW463695 as well.

The present invention has arisen to mitigate and/or obviate the afore-described disadvantages.

### SUMMARY OF THE INVENTION

The major object of the present invention is to provide a locking pliers, wherein a sleeve is provided for preventing a user from being pinched by an operation member and a movable grip, and the sleeve will not fall off easily. The locking pliers has a simple structure and is light.

A locking pliers is provided, including a first clamp assembly, a second clamp assembly, a connecting member and an adjustment threaded rod. The first clamp assembly has a fixed jaw and a fixed grip, and the fixed jaw is fixedly disposed on an end of the fixed grip. The second clamp assembly has a movable jaw, a movable grip, an operation member and a sleeve, the movable jaw is pivoted to the first clamp assembly, the movable grip is swingably assembled to the movable jaw and drives the movable jaw to be near or away from the fixed jaw, the sleeve is sleeved on the operation member, and the sleeve and the operation member are coaxially pivoted to the movable grip. An end of the connecting member is pivoted to the movable grip and the other end thereof is movably assembled to the fixed grip, and the connecting member selectively abuts against the operation member. The adjustment threaded rod is movably screwed to the other end of the fixed grip and abuts against the other end of the connecting member movably assembled to the fixed grip.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is a partial perspective view of FIG. 1 from another perspective;

FIG. 3 is a breakdown view of the preferred embodiment of the present invention;

FIG. 4 is a partial perspective view of FIG. 3 from another perspective; and

FIGS. 5 and 6 are cross-sectional views showing the preferred embodiment of the present invention in operation.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

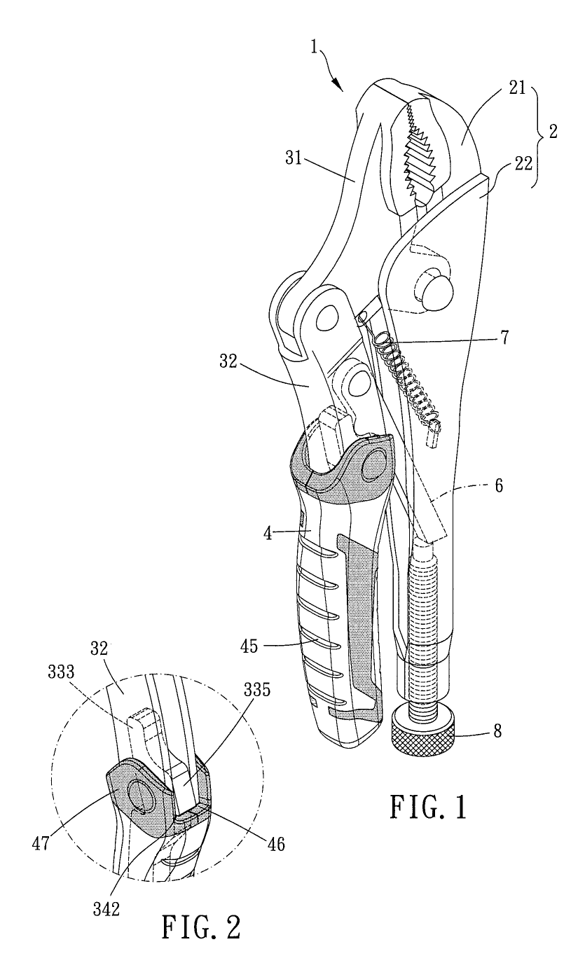

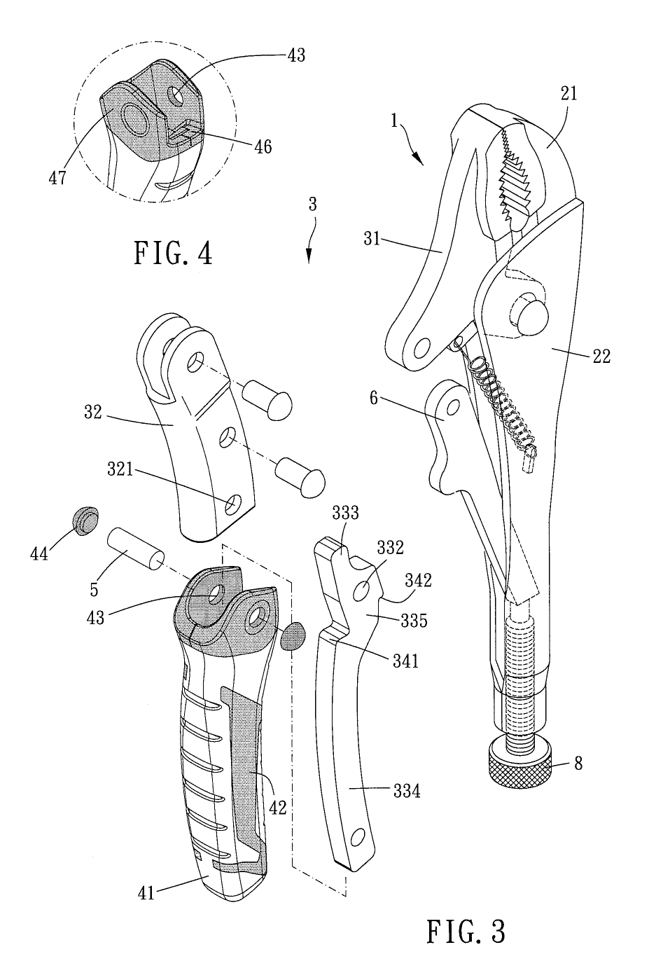

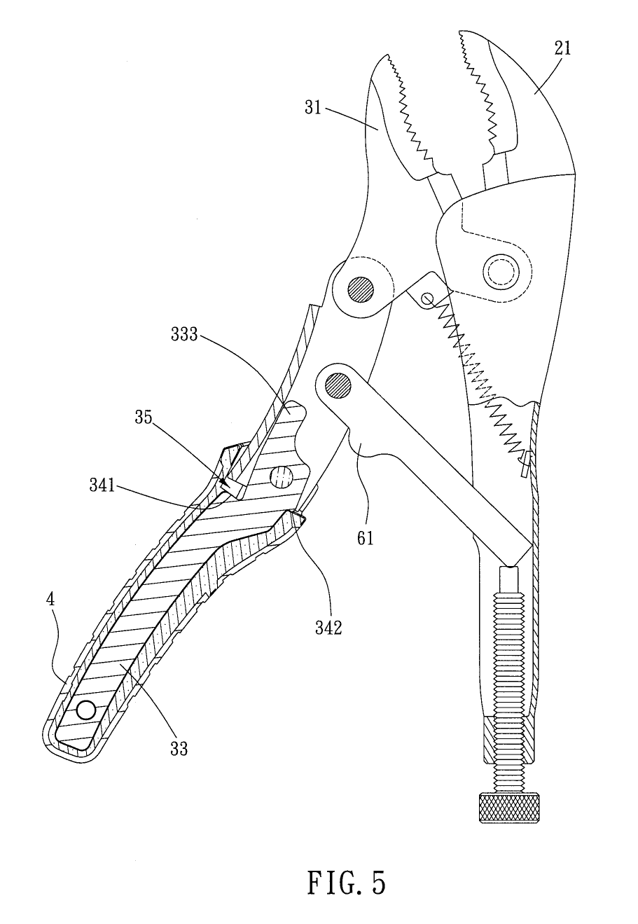

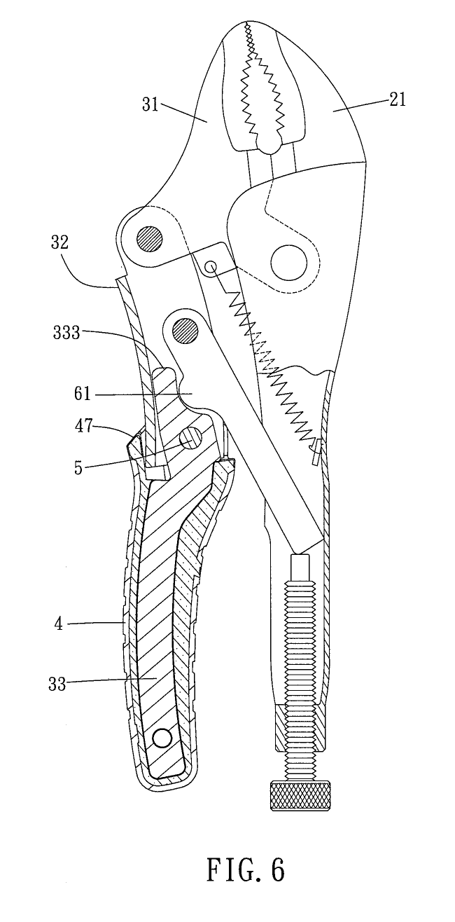

Please refer to FIGS. 1 to 6 for a preferred embodiment of the present invention. A locking pliers 1 includes a first clamp assembly 2, a second clamp assembly 3, a connecting member 6 and an adjustment threaded rod 8.

The first clamp assembly 2 has a fixed jaw 21 and a fixed grip 22, and the fixed jaw 21 is fixedly disposed on an end of the fixed grip 22. The second clamp assembly 3 has a movable jaw 31, a movable grip 32, an operation member 33 and a sleeve 4, the movable jaw 31 is pivoted to the first clamp assembly 2, the movable grip 32 is swingably assembled to the movable jaw 31 and drives the movable jaw 31 to be near or away from the fixed jaw 21, the sleeve 4 is sleeved on the operation member 33, and the sleeve 4 and the operation member 33 are coaxially pivoted to the movable grip 32. An end of the connecting member 6 is pivoted to the movable grip 32 and the other end thereof is movably assembled to the fixed grip 22, and the connecting member 6 selectively abuts against the operation member 33. The adjustment threaded rod 8 is movably screwed to the other end of the fixed grip 22 and abuts against the other end of the connecting member 6 movably assembled to the fixed grip 22.

Specifically, the movable grip 32 has two first through holes 321, the operation member 33 has a second through hole 332, the sleeve 4 has at least one third through hole 43, the second through hole 332 is between the two first through holes 321, one of the two first through holes 321 is between the second through hole 332 and the at least one third through hole 43, a pivotal axle 5 is disposed through the two first through holes 321, the second through hole 332 and the at least one third through hole 43, and the operation member 33 and the sleeve 4 are swingable about the pivotal axle 5 relative to the movable grip 32. In this embodiment, the sleeve 4 has two said third through holes 43. In addition, it is understandable that the movable jaw 31 and the fixed jaw 21 form a jaw opening, the movable jaw 31, the movable grip 32, the connecting member 6 and the adjustment threaded rod 8 are in a link-up relation, and through rotating the adjustment threaded rod 8, a user can adjust a tightness of the jaw opening clamping an object.

Specifically, the connecting member 6 further includes an abutting portion 61, the operation member 33 further includes a pushing portion 333, and when the fixed grip 22 and the movable grip 32 approach each other; that is, when the locking pliers 1 clamps the object, the abutting portion 61 abuts against the pushing portion 333. When the user is to release the object, s/he only needs to press the operation member 33, and then the pushing portion 333 pushes the abutting portion 61 and actuates the connecting member 6 to move so as to drive the movable jaw 31 to move away from the fixed jaw 21 and release the object. Preferably, the locking pliers 1 further includes an elastic member 7, the elastic member 7 is connected to the movable jaw 31 and the fixed grip 22, and the movable jaw 31 has a tendency to move away from the fixed jaw 21 so that the object can be released quickly.

It is understandable that the sleeve 4 coaxially links up with the operation member 33 via the pivotal axle 5; therefore, during a swinging process, the sleeve 4 will not fall off from the operation member 33, and the user can operate the locking pliers 1 stably. It is to be noted that the operation member 33 and the movable grip 32 define a gap 35 therebetween, and the sleeve 4 preferably covers the gap 35 so as to prevent a part of palm of the user from being pinched due to the gap 35. In this embodiment, the operation member 33 further includes a main body 334 and a connecting portion 335, the connecting portion 335 is between the main body 334 and the pushing portion 333, the pushing portion 333 and the connecting portion 335 are in an interior of the movable grip 32, the main body 334 is non-overlapping with the movable grip 32, and the gap 35 is between the main body 334 and the movable grip 32.

Specifically, the connecting portion 335 is pivoted to the movable grip 32 and forms a first stepped portion 341 and a second stepped portion 342 with the main body 334, the second stepped portion 342 is between the first stepped portion 341 and the fixed grip 22, the first stepped portion 341 faces the movable grip 32 and defines the gap 35 with the movable grip 32, the second stepped portion 342 faces toward a direction away from the movable grip 32, and the sleeve 4 covers the gap 35 and abuts against the second stepped portion 342. Specifically, the sleeve 4 further includes an engaging portion 46 and two wing portions 47 facing each other, the engaging portion 46 and the second stepped portion 342 abut against each other, each of the two wing portions 47 is connected to the engaging portion 46 and surrounds the gap 35, and the wing portion 47 has the third through hole 43. Preferably, the sleeve 4 further includes two cover members 44, and the two cover members 44 respectively cover the two third through holes 43 to prevent trivial matters from entering the third through hole 43 and prevent the locking pliers 1 from swinging unsmoothly.

In this embodiment, the sleeve 4 is made of plastic, the sleeve 4 is not excessively greater than the locking pliers 1 in weight, and the sleeve 4 is formed through injection molding to elevate a manufacturing speed. In addition, the sleeve 4 further includes a first region 41 and a second region 42, the first and second regions 41, 42 are in different colors and interleavingly connected to each other, and the second region 42 is greater than the first region 41 in hardness. The second region 42 includes the two wing portions 47, and each of the two wing portions 47 has a stronger structure to be connected with the pivotal axle 5. The first region 41 has a softer texture, so the first region 41 is for contacting the palm and fingers of the user so that the user can grip the locking pliers 1 comfortably. Preferably, the sleeve 4 further includes a plurality of anti-slip portions 45 so that the user can grip the locking pliers 1 stably. In this embodiment, each of the plurality of anti-slip portions 5 is a groove and located in the first region 41. Of course, in other embodiments, a surface of the first region may be greater than a surface of the second region in roughness to provide an anti-slip effect.

Given the above, in the locking pliers, the sleeve can cover the gap between the operation member and the movable grip to prevent fingers of the user from being pinched. The sleeve is light, so it is convenient for the user to use the locking pliers. In addition, the sleeve coaxially links up with the operation member directly, so the sleeve will not fall off easily. The sleeve is made of two materials, so a structural strength and a gripping comfort are enhanced.

While we have shown and described various embodiments in accordance with the present invention, it should be clear to those skilled in the art that further embodiments may be made without departing from the scope of the present invention.

What is claimed is:

1. A locking pliers, including:
a first clamp assembly, having a fixed jaw and a fixed grip, the fixed jaw fixedly disposed on an end of the fixed grip;
a second clamp assembly, having a movable jaw, a movable grip, an operation member and a sleeve, the movable jaw pivoted to the first clamp assembly, the movable grip swingably assembled to the movable jaw and driving the movable jaw to be near or away from the fixed jaw, the sleeve sleeved on the operation member, the sleeve and the operation member coaxially pivoted to the movable grip;
a connecting member, an end thereof pivoted to the movable grip and the other end thereof movably assembled to the fixed grip, the connecting member selectively abutting against the operation member;
an adjustment threaded rod, movably screwed to the other end of the fixed grip and abutting against the other end of the connecting member movably assembled to the fixed grip.

2. The locking pliers of claim 1, wherein the movable grip has two first through holes, the operation member has a second through hole, the sleeve has at least one third through hole, the second through hole is between the two first through holes, one of the two first through holes is between the second through hole and the at least one third through hole, a pivotal axle is disposed through the two first through holes, the second through hole and the at least one third through hole, and the operation member and the sleeve are swingable about the pivotal axle relative to the movable grip.

3. The locking pliers of claim 1, further including an elastic member, the elastic member connected to the movable jaw and the fixed grip, and the movable jaw having a tendency to move away from the fixed jaw.

4. The locking pliers of claim 1, wherein the connecting member further includes an abutting portion, the operation member further includes a pushing portion, and when the fixed grip and the movable grip approach each other, the abutting portion abuts against the pushing portion.

5. The locking pliers of claim 1, wherein the operation member and the movable grip define a gap therebetween, and the sleeve covers the gap.

6. The locking pliers of claim 5, wherein the operation member further includes a main body and a connecting portion, the connecting portion is pivoted to the movable grip and forms a first stepped portion and a second stepped portion with the main body, the second stepped portion is between the first stepped portion and the fixed grip, the first stepped portion faces the movable grip and defines the gap with the movable grip, the second stepped portion faces toward a direction away from the movable grip, and the sleeve covers the gap and abuts against the second stepped portion.

7. The locking pliers of claim 1, wherein the sleeve further includes two cover members, and the two cover members respectively cover the two third through holes.

8. The locking pliers of claim 1, wherein the sleeve further includes a plurality of anti-slip portions.

9. The locking pliers of claim 1, wherein the sleeve includes a first region and a second region, and the first and second regions are in different colors and interleavingly connected to each other.

10. The locking pliers of claim 9, wherein the second region is greater than the first region in hardness.

11. The locking pliers of claim 10, further including an elastic member, the elastic member connected to the movable jaw and the fixed grip, the movable jaw having a tendency to move away from the fixed jaw; the connecting member further including an abutting portion, the operation member further including a pushing portion, when the fixed grip and the movable grip approach each other, the abutting portion abuts against the pushing portion; the operation member and the movable grip defining a gap therebetween, the sleeve covering the gap; the operation member further including a main body and a connecting portion, the connecting portion being between the main body and the pushing portion, the pushing portion and the connecting portion being in an interior of the movable grip, the main body being non-overlapping with the movable grip, the connecting portion pivoted to the movable grip and forming a first stepped portion and a second stepped portion with the main body, the second stepped portion being between the first stepped portion and the fixed grip, the first stepped portion facing the movable grip and defining the gap with the movable grip, the second stepped portion facing toward a direction away from the movable grip, the sleeve covering the gap and abutting against the second stepped portion; the sleeve further including an engaging portion and two wing portions facing each other, the engaging portion and the second stepped portion abutting against each other, each of the two wing portions being connected to the engaging portion and surrounding the gap, the wing portion having the third through hole; the sleeve further including two cover members, the two cover members respectively covering the two third through holes; the first region for contacting a palm and fingers of a person; the sleeve further including a plurality of anti-slip portions, each of the plurality of anti-slip portions being a groove and located in the first region.
